(19) United States
(12) Patent Application Publication
(10) Pub. No.: US 2008/0211618 A1
(43) Pub. Date: Sep. 4, 2008

(54) Chip Type Variable Electronic Part and Chip Type Variable Resistor

(75) Inventors: Akiko Araki, Osaka (JP); Tadatoshi Miwa, Kyoto (JP)

Correspondence Address: HAMRE, SCHUMANN, MUELLER & LARSON, P.C., P.O. BOX 2902, MINNEAPOLIS, MN, 55402-0902, US

(73) Assignee: ROHM CO., LTD., Kyoto-shi (JP)

(21) Appl. No.: 11/596,841

(22) PCT Filed: Apr. 13, 2005
(86) PCT No.: PCT/JP05/07151

§ 371 Date: Nov. 17, 2006

(30) Foreign Application Priority Data
May 20, 2004 (JP) 2004-150868
May 20, 2004 (JP) 2004-150871

(51) Int. Cl. H01C 10/32

(52) U.S. Cl. 338/166

(57) ABSTRACT

A chip type variable electronic part includes an insulating substrate with a through hole, an adjustment rotor formed of a metal plate in a bowl shape and disposed on the upper surface of the insulating substrate, an internal terminal electrode plate made of a metal plate disposed in close contact with the lower surface of the insulating substrate, and a hollow shaft integrally formed with the internal terminal electrode plate to be fitted in the through hole. The adjustment rotor has a bottom plate rotatably fitted to an upper end portion of the hollow shaft so that the bottom plate makes close contact with the surface of the insulating substrate. The upper end portion of the hollow shaft is crimped to outwardly extend. The bottom plate of the adjustment rotor is smaller in thickness than the remaining portions. Thus, the overall height is reduced without reducing the insertion depth of a screwdriver into the rotor, and without degrading the strength of the insulating substrate.

### TECHNICAL FIELD

The present invention relates to a chip type variable electronic part and a variable resistor constituted of an insulating substrate in the form of a chip, with a rotor for controlling e.g. the resistance value or capacitance that is rotatably mounted on the substrate.

### BACKGROUND ART

A conventional chip type variable resistor, an example of variable electronic parts, may include an insulating substrate in the form of a chip formed with a through hole at a central portion. The substrate is formed with a resistance film on its upper surface that is in an arcuate shape concentric with the through hole. External terminal electrodes corresponding to the respective end portions of the arcuate resistance film are provided on the insulating substrate, and an internal terminal electrode plate made of a metal plate is attached to the lower surface of the insulating substrate. The internal terminal electrode includes an integrally formed hollow shaft that fits in the through hole. On the upper surface side of the insulating substrate, an adjustment rotor formed of a metal plate in a bowl shape and including a sliding piece that makes contact with the resistance film, is fitted over an upper end portion of the hollow shaft such that a bottom portion of the rotor makes close contact with the upper surface of the insulating substrate. The rotor is rotatably mounted on the insulating substrate by crimping the upper end portion of the hollow shaft to outwardly extend, thereby allowing insertion of a screwdriver into the inside of the rotor for rotating the rotor.

Also, in the conventional chip type variable resistor, a film is adhered to a lower surface of that covers the inside of the shaft portion 9 is adhered to the lower surface of the internal terminal electrode plate to cover the hollow shaft, thereby preventing intrusion of a flux produced by a soldering process into an inner portion of the rotor through the hollow shaft, when implementing the resistor on a PCB or the like by soldering.

Now, the adjustment rotor is designed to receive insertion of a screwdriver that rotates the rotor into an inner portion thereof. For the screwdriver to be sufficiently engaged with the rotor, a certain insertion depth for the screwdriver has to be secured inside the rotor, which compels the rotor formed in a bowl shape to have, a certain height and hence the overall height of, the chip type variable resistor is increased.

Also, in the case where the film is adhered to the lower surface of the internal terminal electrode plate, the film protrudes from the lower surface of the internal terminal electrode plate, which leads to an additional increase in overall height of the chip type variable -resistor, by the same amount as the thickness of the film.

Accordingly, the patent document 1 proposes forming a partial recess on the upper surface of the insulating substrate in a region corresponding to a bottom portion of the adjustment rotor, thus to reduce the overall height by the same amount as the recessed depth.

Also, the patent document 2 proposes forming a recessed portion on the lower surface of the insulating substrate at a position corresponding to the through hole, and fitting the hollow shaft of the internal terminal electrode plate into the recessed portion, thereby preventing the protrusion of the film thus excluding the thickness thereof from the overall height.

When forming the partial recess in the upper surface of the insulating substrate as described in the patent document 1, in order to reduce the overall height, the recess has to be made as deep as the desired decrease in overall height, which leads not only to an increase in manufacturing cost of the insulating substrate by the same amount as what is required for the process of forming the partial recess on the upper surface thereof, but also to degradation in strength of the insulating substrate, thereby resulting in frequent cracking thereof, in the manufacturing process as well as in the implementation on a PCB.

Besides, forming the partial recessed portion on the lower surface of the insulating substrate, as described in the patent document 1, to absorb the thickness of the film adhered to the lower surface of the internal terminal electrode plate leads likewise to an increase in manufacturing cost of the insulating substrate by the same amount as what is required for the process of forming the partial recess on the lower surface thereof, and also to degradation in strength of the insulating substrate, thereby resulting in frequent cracking thereof, in the manufacturing process as well as in the implementation on a PCB.

Especially, when the recessed portion is provided on the lower surface of the insulating substrate, in addition to the partial recess on the upper surface thereof, the foregoing problem becomes more evident.

Patent document 1: JP-A-H09-260116

Patent document 2: JP-U-H02-102703

### DISCLOSURE OF THE INVENTION

### Problems to be Solved by the Invention

A technical object of the present invention is to provide a chip type variable electronic part and a variable resistor in which the foregoing problems are minimized.

### Means for Solving the Problems

To achieve the technical object, a first aspect of the present invention provides a chip type variable electronic part including an insulating substrate with a through hole, an adjustment rotor formed of a metal plate in a bowl shape and disposed on an upper surface of the insulating substrate, an internal terminal electrode plate made of a metal plate disposed in close contact with a lower surface of the insulating substrate, and a hollow shaft integrally formed with the internal terminal electrode plate to be fitted in the through hole, in which a bottom plate of the adjustment rotor is rotatably fitted over an upper end portion of the hollow shaft such that the bottom plate makes close contact with a surface of the insulating substrate, and the upper end portion of the hollow shaft is crimped to outwardly extend, wherein a plate thickness of the bottom plate of the adjustment rotor is thinner than a plate thickness of the remaining portion thereof.

A second aspect of the present invention provides a chip type variable electronic part including an insulating substrate with a through hole, an adjustment rotor formed of a metal plate in a bowl shape and disposed on an upper surface of the, an internal terminal electrode plate made of a metal plate disposed in close contact with a lower surface of the insulating substrate, and a hollow shaft integrally formed with the internal terminal electrode plate to be fitted in the through hole, in which a bottom plate of the adjustment rotor is rotatably fitted over an upper end portion of the hollow shaft such that the bottom plate makes close contact with a surface of the insulating substrate, the upper end portion of the hollow shaft is crimped to outwardly extend, and a film that covers an inner portion of the hollow shaft is adhered to a lower surface of the internal terminal electrode plate at a position corresponding to the hollow shaft, wherein a plate thickness of the position on the internal terminal electrode plate where the film is provided is thinner than a plate thickness of the remaining portion thereof.

A third aspect of the present invention provides the chip type variable electronic part according to the first aspect or the second aspect, wherein the rotor includes a first plate having the bottom plate and a second plate integrally connected to the first plate via a fold-back joint such that the second plate is superposed on the first plate, and the fold-back joint includes an opening perforated therethrough while a cross-shaped screwdriver engagement hole is provided on the second plate, such that the opening is located between the respective slots of the screwdriver engagement hole arranged in a cross-shape.

A fourth aspect of the present invention provides the chip type variable electronic part according to any of the first to the third aspects, wherein the internal terminal electrode plate includes a stopper piece projecting from the upper surface of the insulating substrate to be butted to the rotor thereby delimiting a rotation angle thereof, to a height not exceeding an uppermost portion of the rotor.

A fifth aspect of the present invention provides the chip type variable electronic part according to the fourth aspect, wherein the stopper piece includes an abutment portion butted to the upper surface of the insulating substrate to hold the insulating substrate in cooperation with the internal terminal electrode plate.

A sixth aspect of the present invention provides the chip type variable electronic part according to any of the first to the fifth aspects, further comprising, on the insulating substrate, a resistance film of an arcuate shape concentric with the through hole, and an external terminal electrode corresponding to the respective end portions of the resistance film, wherein the adjustment rotor includes a sliding piece disposed in sliding contact with the resistance film.

### Advantageous Effect of the Invention

Making the plate thickness of the bottom plate of the adjustment rotor thinner than the plate thickness of the remaining portion thereof, according to the first aspect, permits reducing the height of the rotor by the same amount as the reduction in plate thickness of the bottom plate of the rotor, without reducing the insertion depth of a screwdriver into the rotor, thereby enabling skipping the process of forming the partial recess on the upper surface of the insulating substrate according to the patent document 1 in order to reduce the overall height of the chip type variable electronic part, or at least reducing the depth of the recess, even though the upper surface of the insulating substrate has to be recessed at all, by the same amount as the reduction in plate thickness of the bottom plate of the rotor.

Further, making the plate thickness of the position on the internal terminal electrode plate where the film is provided thinner than the plate thickness of the remaining portion thereof, and additionally making the plate thickness of the position on the internal terminal electrode plate where the film is provided thinner than the plate thickness of the remaining portion thereof according to the second aspect, permits skipping the process of forming the partial recess on the upper surface of the insulating substrate and/or forming the partial recess on the lower surface of the insulating substrate, or at least reducing the depth of the recess on the upper surface of the insulating substrate and/or on the lower surface of the insulating substrate, while maintaining the sufficient insertion depth of the screwdriver into the rotor and without increasing the overall height of the chip type variable electronic part, thereby significantly reducing the manufacturing cost of the insulating substrate in comparison with the conventional process and effectively preventing the cracking of the insulating substrate during the fabrication thereof and in the process of implementing on a PCB.

Constituting the rotor, according to the third aspect, to include the first plate having the bottom plate and the second plate integrally connected to the first plate via the fold-back joint such that the second plate is superposed on the first plate, and providing the fold-back joint with an opening perforated therethrough and the second plate with the cross-shaped screwdriver engagement hole, such that the opening is located between the respective slots of the screwdriver engagement hole arranged in a cross-shape, provides the fold-back joint with sufficient strength against a transverse torsional deformation between the first plate and the second plate without complicating the bending work of the fold-back joint, and allows preventing degradation in strength of the second plate for the process of perforating the opening and the cross-shaped screwdriver engagement hole.

Providing the internal terminal electrode plate with a stopper piece projecting from the upper surface of the insulating substrate to be butted to the rotor thereby delimiting a rotation angle thereof, to a height not exceeding the uppermost portion of the rotor according to the fourth aspect, permits reducing the projecting height of the stopper piece from the upper surface of the insulating substrate by the same amount as the reduction in height of the rotor, thereby increasing the strength of the stopper piece against tilting in the rotation direction of the rotor, and prevents the stopper piece from increasing the overall height.

In the fourth aspect, forming the abutment portion to be butted to the upper surface of the insulating substrate, to hold the insulating substrate in cooperation with the internal terminal electrode plate according to the fifth aspect, significantly increases the strength of the-stopper piece against tilting in the rotation direction of the rotor because of the contact of the abutment portion with the upper surface of the insulating substrate, without increasing the width of the stopper piece or the plate thickness of the internal terminal electrode plate as conventionally adopted, which leads to reduction in size and weight of the electronic part. Moreover, holding the insulating substrate with the internal terminal electrode plate and the abutment portion remarkably increases the sticking strength of the internal terminal electrode plate to the insulating substrate, in comparison with the conventional case where the internal terminal electrode plate is attached to the insulating substrate exclusively by crimping the upper end portion of the shaft portion to mount the rotor.

Especially, the configuration according to the sixth aspect is advantageous in effectively achieving the foregoing effects in the chip type variable resistor.

### BRIEF DESCRIPTION OF THE DRAWINGS

FIG. 1 is a plan view showing a variable resistor according to an embodiment of the present invention;

FIG. 2 is a cross-sectional view taken along the line II-II in FIG. 1;

FIG. 3 is an exploded cross-sectional view based on FIG. 2;

FIG. 4 is a plan view showing an unfolded rotor;

FIG. 5 is a plan view showing a state where the rotor is rotated;

FIG. 6 is a cross-sectional view showing a modified stopper;

FIG. 7 is a cross-sectional view taken along the line VII-VII in FIG. 6

FIG. 8 is a cross-sectional view showing another modified stopper;

FIG. 9 is a right side view of FIG. 8;

FIG. 10 is a cross-sectional view showing still another modified stopper;

FIG. 11 is a right side view of FIG. 10; and

FIG. 12 is a cross-sectional view taken along the line XII-XII in FIG. 10.

### REFERENCE NUMERALS

1 chip type variable resistor

2 insulating substrate

3 adjustment rotor

4 internal terminal electrode plate

5 through hole

6 resistance film

7, 8 external terminal electrode

9 hollow shaft

10, 10′, 100, 100′ stopper piece

11 the first plate

12 fold-back joint

13 the second plate

14 screwdriver engagement hole

16 sliding piece

17 bottom plate

18 mounting hole

19 film

10a, 4a, 4b abutment portion

### BEST MODE FOR CARRYING OUT THE INVENTION

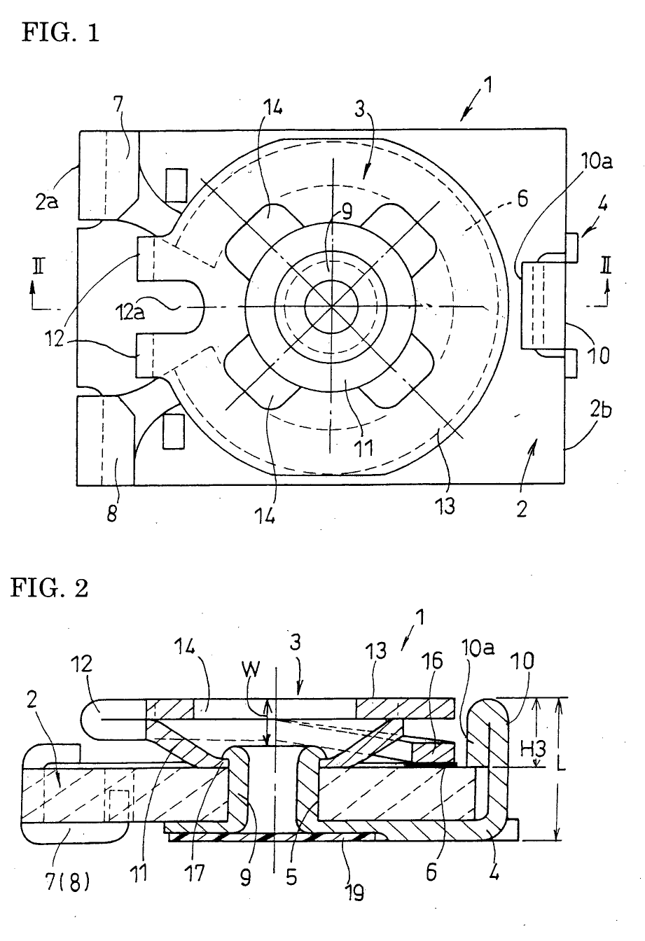

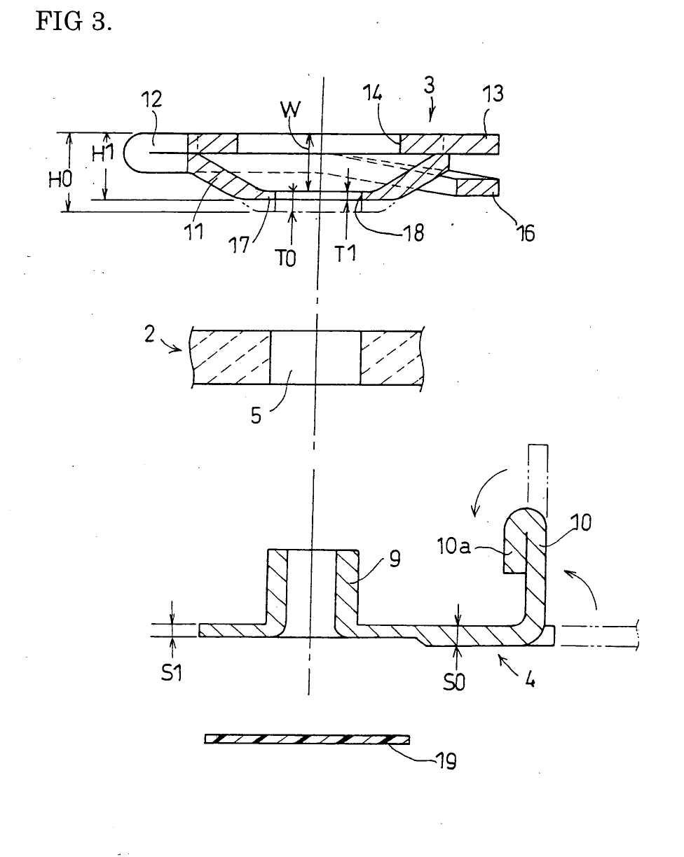

An embodiment of the present invention will be described below referring to the drawings, in which the present invention is applied to a chip type variable resistor (FIGS. 1 to 5).

In these figures, the reference numeral 1 designates a chip type variable resistor. The chip type variable resistor 1 includes an insulating substrate 2 in the form of a chip made of a heat-resistant insulating material such as a ceramic, an adjustment rotor 3 disposed on the insulating substrate 2, and an internal terminal electrode plate 4 disposed on the lower surface of the insulating substrate 2.

The insulating substrate 2 is formed with a through hole 5 extending from the upper surface to the lower surface of the substrate at a generally central position, and a resistance film 6 disposed to extend thereon in an arcuate shape concentric with the through hole 5, and the insulating substrate 2 is provided, on a lateral face 2a thereof, with external terminal electrodes 7, 8 corresponding to the respective end portions of the resistance film 6.

The internal terminal electrode plate 4 is made of a metal plate of an appropriate plate thickness S0 and disposed in close contact with the lower surface of the insulating substrate 2, and includes a hollow shaft 9 integrally formed therewith at a position corresponding to the through hole 5 to be inserted into the through hole 5, and a stopper piece 10 integrally formed therewith to be bent upward along another lateral portion 2b of the insulating substrate 2.

The rotor 3 includes a first plate 11 made of a metal plate of an appropriate plate thickness T0 and formed in a bowl shape with a flange around an outer periphery thereof, and a plate-shaped second plate 13 integrally connected to the first plate 11 via a fold-back joint 12, and the second plate 13 includes a cross-shaped screwdriver engagement hole 14 perforated therethrough, and is bent to be folded back at the fold-back joint 12 thus to be superposed on the upper surface of the first plate 11, while the flange on the outer periphery of the first plate 11 includes, as shown in FIG. 4, a slit hole 15 perforated in a generally semicircular arc in a region opposite to the fold-back joint 12, and a portion of the flange radially outer from the slit hole 15 constitutes a sliding piece 16 to be brought into elastic contact with the resistance film 6.

The rotor 3 is mounted on the upper surface of the insulating substrate 2, such that a mounting hole 18 perforated in a bottom plate 17 of the first plate 11 of the rotor 3 is fitted over the hollow shaft portion 9, and then the lower surface of the bottom plate 17 is closely pressed against the upper surface of the insulating substrate 2 and the sliding piece 16 is set in elastic contact with the resistance film 6, after which an upper end portion of the shaft portion 9 is crimped to outwardly extend, so that the rotor 3 is attached to the shaft portion 9 to freely rotate around the shaft portion 9.

Then the plate thickness T1 of the bottom plate 17 of the first plate 11 of the rotor 3 is made thinner than the designed plate thickness T0 of the metal plate constituting the rotor 3, so that the rotor 3 is brought into close contact with the upper surface of the insulating substrate 2 via the portion of the bottom plate 17 with the reduced plate thickness T1, thus to be rotatably mounted on the hollow shaft 9.

Also, the plate thickness S1 of a region around the hollow shaft 9 integrally formed with the internal terminal electrode plate 4 is made thinner than the designed plate thickness S0 of the metal plate constituting the internal terminal electrode plate 4, and a film 19 of a heat-resistant synthetic resin is adhered to the lower surface of the region with the reduced thickness, to cover an inner portion of the hollow shaft 9 with the film 19.

Methods of reducing the thickness of the bottom plate 17 of the first plate 11 of the rotor 3 from the original plate thickness T0 to the plate thickness T1 include a coining process of pinching the bottom plate 17 with two dies, grinding or cutting the lower surface of the bottom plate 17, and a corrosion process.

Likewise, methods of reducing the thickness of the region around the hollow shaft of the internal terminal electrode plate 4 from the original plate thickness S0 to the plate thickness S1 include a coining process of pinching the bottom plate 17 with two dies, grinding or cutting the lower surface of the bottom plate 17, and a corrosion process.

As stated earlier, making the plate thickness T1 of the bottom plate 17 of the adjustment rotor 3 thinner than the plate thickness T0 of the remaining portion thereof permits reducing the height H1 of the rotor 3 by the same amount as the reduction in plate thickness of the bottom plate 17 of the rotor 3, from the height H0 based on the designed plate thickness T0 of the bottom plate 17, without reducing the insertion depth W of a screwdriver into the rotor 3, thereby enabling skipping the process of forming the partial recess on the upper surface of the insulating substrate according to the patent document 1 in order to reduce the overall height L of the chip type variable electronic part 1, or at least reducing the depth of the recess, even though the upper surface of the insulating substrate has to be recessed at all, by the same amount as the reduction in plate thickness of the bottom plate of the rotor.

Further, as already stated, making the plate thickness S1 of the position on the internal terminal electrode plate 4 where the film 19 is adhered, i.e. the region around the hollow shaft 9, thinner than the plate thickness S0 of the remaining portion thereof, permits reducing the overall height L of the chip type variable electronic part 1 by the same amount as the reduction in plate thickness S1 of the position of the internal terminal electrode plate 4 where the film 19 is adhered, even without forming the recess on the lower surface of the insulating substrate 2 for the internal terminal electrode plate 4 to be fitted in, or at least reducing, when the lower surface of the insulating substrate 2 has to be recessed for the internal terminal electrode plate 4 to be fitted in, the depth of the recess on the lower surface of the insulating substrate 2 by the same amount as the reduction in plate thickness S1 of the position of the internal terminal electrode plate 4 where the film 19 is adhered.

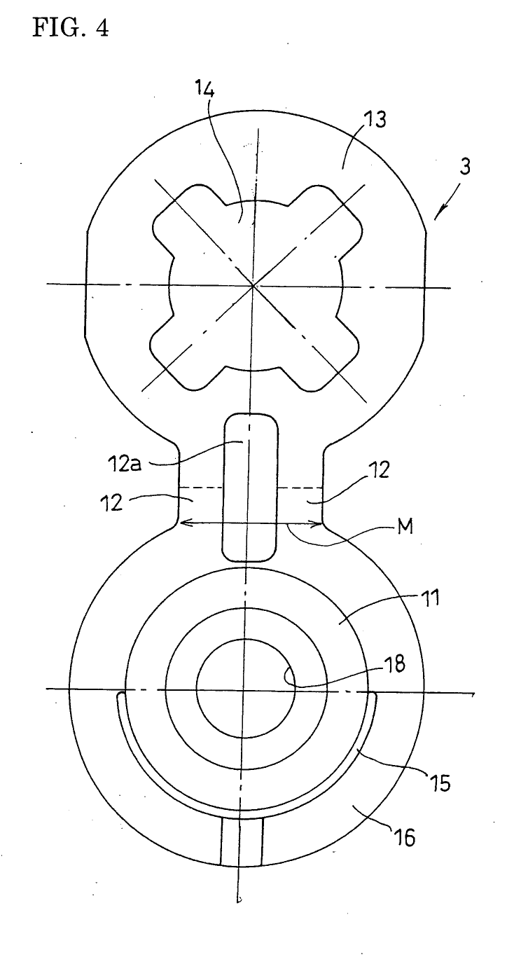

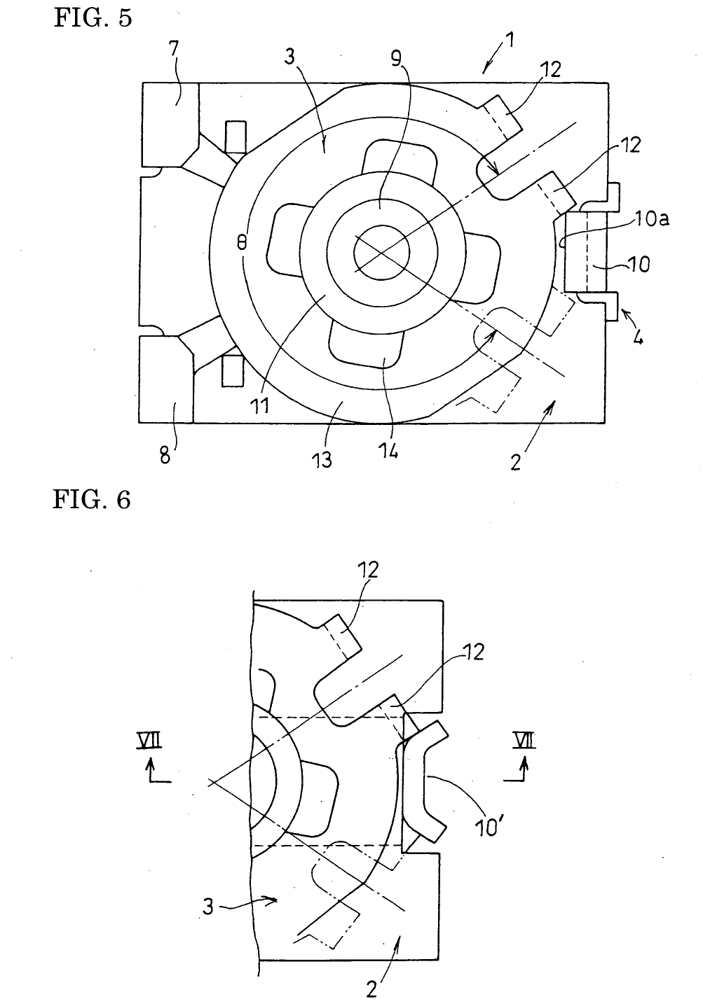

When the rotor 3 is rotated, the fold-back joint 12 of the rotor 3 is butted to the stopper piece 10 upwardly projecting from the upper surface of the insulating substrate 2 as shown in FIG. 5, and the rotation range of the rotor 3 is thereby delimited within an angle of θ.

Since the stopper piece 10 is provided so as not to protrude from the uppermost portion of the rotor 3, the overall height L is not affected at all by the stopper mechanism, and besides the projecting height 3H of the stopper piece 10 from the upper surface of the insulating substrate 2 can be made lower by the same amount as the reduction in height of the rotor 3 from H0 to H1, which leads to an increase in strength of the stopper piece 10 against tilting in the rotation direction of the rotor 3 thus to be deformed, i.e. the strength against tilting.

In the embodiment shown in FIGS. 1 to 5, an upper end portion of the stopper piece 10 is bent downward to be butted to the upper surface of the insulating substrate 2.

Such configuration causes the stopper piece 10 to hold the insulating substrate 2 from an upper and lower direction, thereby increasing the strength of the stopper piece 10 and the attaching strength of the internal terminal electrode plate 4 to the insulating substrate 2.

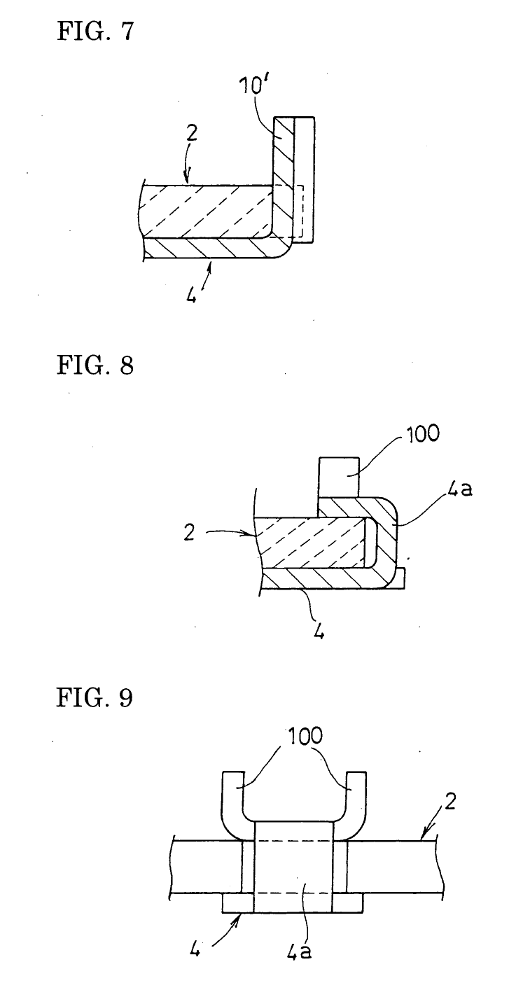

Here, without limitation to the foregoing structure, it is a matter of course that the stopper piece may be formed into a stopper piece 10′ in a shape having an upwardly open C-shaped cross-section and bent upward, as the modification shown in FIGS. 6 and 7. Such configuration leads to an increase in strength against tilting in the rotation direction of the rotor 3 because of the C-shaped cross-sectional shape, despite that the stopper piece 10′ does not include the abutment portion to be butted to the upper surface of the insulating substrate 2.

Now, FIGS. 8 and 9 depict a second modification of the stopper piece.

The second modification represents a stopper piece 100, formed by first bending upward the internal terminal electrode plate 4 provided on the lower surface of the insulating substrate 2 to form an abutment portion 4a folded back to be butted to the upper surface of the insulating substrate 2, and then bending upward a left and right end portion of the abutment portion 4a, so that the fold-back joint 12 of the rotor 3 is butted to the bent portion.

In the second modification, substantially the stopper piece 100 includes the abutment portion 4a butted to the upper surface of the insulating substrate 2, which leads, as the foregoing stopper piece 10, to a significant increase in strength of the stopper piece 100 against tilting in the rotation direction of the rotor 3, as well as to an increase in attaching strength of the internal terminal electrode plate 4 to the insulating substrate 2.

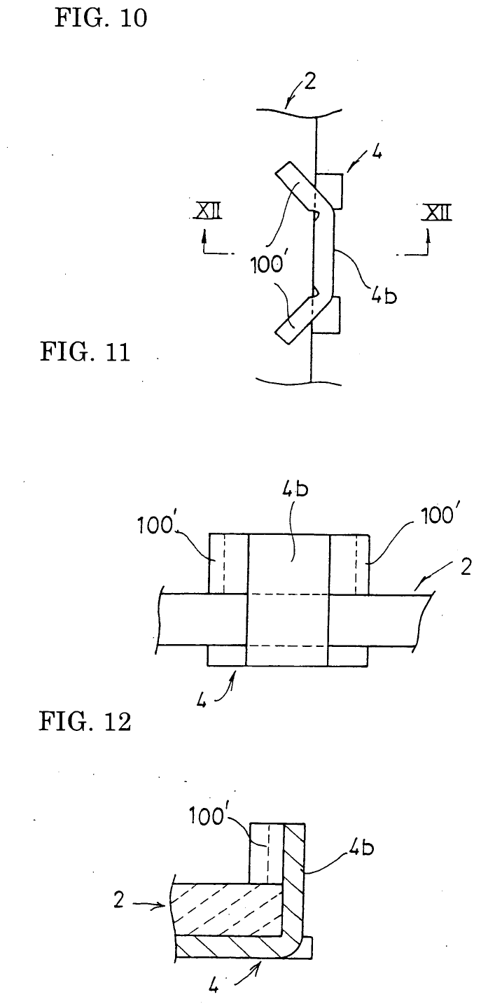

FIGS. 10 to 12 depict a third modification of the stopper piece.

The third modification represents a stopper piece 100′, formed by first bending upward the internal terminal electrode plate 4 provided on the lower surface of the insulating substrate 2 to form an abutment portion 4b folded back to be butted to the upper surface of the insulating substrate 2, and then bending inward a left and right end portion of the abutment portion 4b, so that the fold-back joint 12 of the rotor 3 is butted to the bent portion.

In the third modification also, substantially the stopper piece 100′ includes the abutment portion 4b butted to the upper surface of the insulating substrate 2, which leads, as the foregoing stopper piece 10, to a significant increase in strength of the stopperpiece 100′ against tilting in the rotation direction of the rotor 3, as well as to an increase in attaching strength of the internal terminal electrode plate 4 to the insulating substrate 2.

In the foregoing illustrated embodiment, forming the fold-back joint 12 of the rotor 3 in a greater width M and perforating the opening 12a to intrude into both of the first plate 11 and the second plate 13 facilitates the bending work of the fold-back joint 12, while providing the fold-back joint with sufficient strength against a transverse torsional deformation between the first plate and the second plate.

In addition, in the foregoing illustrated embodiment, when perforating the opening 12a in the fold-back joint 12, and the cross-shaped screwdriver engagement hole 14 in the second plate 13 respectively, the orientation of the cross-shaped screwdriver engagement hole 14 is shifted such that the opening 12a is located between the respective slots of the screwdriver engagement hole 14 arranged in a cross-shape, which prevents degradation in strength of the second plate 13 for the process of perforating the opening 12a and the cross-shaped screwdriver engagement hole 14 in the second plate 13.

It should be noted that the present invention is obviously applicable to variable electronic parts such as a variable capacitor, in addition to the foregoing chip type variable resistor.

1. A chip type variable electronic part comprising: an insulating substrate with a through hole; an adjustment rotor made of a metal plate in a bowl shape and disposed on an upper surface of the insulating substrate; an internal terminal electrode plate made of a metal plate disposed in close contact with a lower surface of the insulating substrate; and a hollow shaft integrally formed with the internal terminal electrode plate to be fitted in the through hole; the adjustment rotor including a bottom plate rotatably fitted to an upper end portion of the hollow shaft and making close contact with a surface of the insulating substrate, the upper end portion of the hollow shaft being crimped to outwardly extend,
wherein the bottom plate of the adjustment rotor is smaller in thickness than a remaining portion of the rotor.

2. A chip type variable electronic part comprising: an insulating substrate with a through hole; an adjustment rotor formed of a metal plate in a bowl shape and disposed on an upper surface of the substrate; an internal terminal electrode plate made of a metal plate disposed in close contact with a lower surface of the substrate; and a hollow shaft integrally formed with the internal terminal electrode plate to be fitted in the through hole; the adjustment rotor including a bottom plate rotatably fitted to an upper end portion of the hollow shaft and making close contact with a surface of the insulating substrate, the upper end portion of the hollow shaft being crimped to outwardly extend, the hollow shaft being, on a lower side of the internal terminal electrode plate, provided with a film for covering an inner portion of the hollow shaft,
wherein the bottom plate of the adjustment rotor is smaller in thickness than a remaining portion of the rotor, and wherein the internal terminal electrode plate is smaller in thickness at a portion provided with the film than at a remaining portion of the internal terminal electrode plate.

3. The chip type variable electronic part according to claim 1, wherein the rotor includes a first plate having the bottom plate and a second plate integrally connected to the first plate via a fold-back joint so that the second plate is superposed on the first plate, the fold-back joint being formed with an opening, the second plate being formed with a cross-shaped screwdriver engagement hole in a manner such that the opening is located between slots of the screwdriver engagement hole.

4. The chip type variable electronic part according to claim 1, wherein the internal terminal electrode plate includes a stopper piece projecting from the upper surface of the insulating substrate to be butted to the rotor thereby delimiting a rotation angle thereof, to a height not exceeding an uppermost portion of the rotor.

5. The chip type variable electronic part according to claim 4, wherein the stopper piece includes an abutment portion butted to the upper surface of the insulating substrate to hold the insulating substrate in cooperation with the internal terminal electrode plate.

6. The chip type variable electronic part according to claim 1, further comprising a resistance film of an arcuate shape concentric with the through hole in the substrate, external terminal electrodes corresponding to end portions of the resistance film, and a sliding piece provided on the rotor to be held in sliding contact with the resistance film.
